(19) United States
(12) Patent Application Publication
(10) Pub. No.: US 2008/0171108 A1
(43) Pub. Date: Jul. 17, 2008

(54) Kit For and Method of Preparing a Coffee Beverage

(75) Inventor: Cees Gerardus Johannes Dierikx, Amsterdam (NL)

Correspondence Address: BELL, BOYD & LLOYD LLP, P.O. Box 1135, CHICAGO, IL, 60690, US

(73) Assignee: NESTEC S.A., Vevey (CH)

(21) Appl. No.: 11/911,068

(22) PCT Filed: Mar. 21, 2006
(86) PCT No.: PCT/EP2006/002563

§ 371 Date: Oct. 9, 2007

(30) Foreign Application Priority Data
May 24, 2005 (EP) 05104416.2

(51) Int. Cl. A23F 5/14; A23P 1/16; B65D 85/808

(52) U.S. Cl. 426/77; 426/595; 426/569; 426/87

(57) ABSTRACT

The invention pertains to a kit for preparing a coffee beverage, in particular cappuccino, cafe latte, or Wiener melange or the like, comprising a first container (1) holding at least a coffee beverage ingredient, preferably at least a coffee concentrate, a creamer and/or a foamer, to be dispensed into a receptacle and a second container (2) holding ground coffee.

The invention relates to a kit for preparing a coffee beverage, in particular cappuccino, café latte, Wiener melange or the like. The invention also relates to a method of preparing a coffee beverage.

US 2004/0241307 relates to a method for preparing cappuccino wherein at least one coffee pad filled with ground coffee and an instant and/or liquid creamer are utilized. The method further comprises the following steps: hot water is forced under pressure through the coffee pad for obtaining coffee extract; the coffee extract is supplied under pressure to at least one nozzle for obtaining a coffee extract jet, the coffee extract jet is aimed at a first buffer reservoir already filled with the creamer so that in the first buffer reservoir the cappuccino is formed and the cappuccino is discharged from the first buffer reservoir.

WO 2005/018394 relates to a method for the preparation of a beverage suitable for consumption, such as cappuccino, wherein use is made of at least one extraction pad (44) at least filled with a product to be extracted such as ground coffee (45), and at least one additive holder (32), at least filled with a soluble substance such as a flavouring and/or odorant and/or colorant, more in particular such as an instant and/or liquid creamer (35). FIG. 2d shows a combination of a coffee pad (44) and a creamer pad (32), jointly accommodated in a collecting container (4).

It is an object of the present invention to provide an improved kit.

To this end, the kit according to the invention comprises a first container, preferably a sachet, holding at least a coffee beverage ingredient, preferably at least a coffee concentrate, a creamer and/or a foamer (i.e., one of these ingredients or a combination of these ingredients), to be dispensed into a receptacle, such as a cup, beaker or the like, and a second container, preferably a so-called extraction pad, holding ground coffee.

It is preferred that the first container holds a mixture of at least a powdered coffee concentrate and a powdered creamer and/or foamer.

It is further preferred that the total of coffee solids extractable from the coffee grounds in the second container and coffee concentrate in the first container corresponds to total coffee solids in a specific coffee beverage. More specifically, it is preferred that the total of coffee solids extractable from the coffee grounds in the second container and coffee concentrate in the first container is in a range from 1.4 to 2.1 grams, preferably in a range from 1.5 to 2.0 grams.

Also, it is preferred that the amount of coffee concentrate in the first container is in a range from 0.05 to 0.6 grams, preferably in a range from 0.1 to 0.5 grams and/or that the amount of coffee grounds in the second container is in a range from 5 to 9 grams, preferably in a range from 6 to 8 grams.

It is preferred that the first container holds a powdered soluble foamer ingredient (also referred to as ‘booster’) which, upon addition of a liquid, induces the formation of or forms a foam. It is further preferred that the foamer ingredient comprises a matrix containing carbohydrate and protein, preferably milk protein, and entrapped gas, the gas being present in an amount to release upon addition of liquid at least about 1 ml of gas ambient conditions per gram of soluble foamer ingredient. This type of foamer ingredient may also serve as a creamer.

Preferred foamer ingredients are disclosed in WO 01/08504, which is incorporated herein by reference.

The kit according to the present invention can be used in existing brewing machines, without requiring an additional buffer or necessitating modifications. Further, the contents of the first container can be adjusted to any desired coffee beverage.

The coffee concentrate provides an effective means to compensate for the relatively small amount of coffee solids extractable with brewing machines operating at a relatively low pressure and/or for adjusting the total amount of coffee in the kit to a specific coffee beverage, such as the ones mentioned above.

The invention further pertains to a container, preferably a first container as defined above, holding at least a coffee beverage ingredient, preferably at least a coffee concentrate and/or a foamer, again as defined above, and provided with an indication that it can or should be used in combination with a second container holding ground coffee. E.g., sachets may be provided separately to supplement existing extraction pads.

The invention also pertains to a method of preparing a coffee beverage comprising the steps of dispensing at least a coffee concentrate and/or a foamer, preferably a mixture of a coffee concentrate, a foamer/creamer and, optionally, further ingredients, such as sugar, cacao, vanille and/or cinnamon, into a receptacle, such as a cup, beaker or the like, and dispensing a coffee extract from a coffee brewing machine, in particular a machine employing extraction pads, into the receptacle.

It is preferred that the total of the coffee solids in the extract and coffee concentrate dispensed into the receptacle corresponds to the recipe of a specific coffee beverage.

Although it is certainly possible to first dispense the hot coffee extract into the receptacle and then add the coffee concentrate and/or foamer, dissolution of the concentrate and/or foamer is facilitated if the concentrate and/or foamer are dispensed in the beaker first and the extract is dispensed on top of the concentrate and/or foamer causing the various ingredients to mix thoroughly.

Within the framework of the present invention, the term “extractable” should be construed relative to the type of brewing machine for which the kit is intended. E.g., brewing machines operating at atmospheric pressure and pressures up to 3 bar, such as the so-called Senseo® ex Philips, will, depending on the beans, e.g. Columbia, Arabica, or Robusta, the blend, and the extent of roasting (light, medium, dark), exhibit an extraction yield typically in a range from 18 to 22%, more specifically in a range from 19 to 21%. Brewing machines operating at pressures around 15 bar, such as professional espresso machines in cafés and restaurants and the so-called Nespresso® ex Nestlé, will exhibit an extraction yield typically in a range from 23 to 27%, more specifically in a range from 24 to 26%. If, for instance, a coffee beverage is brewed from 7 grams of coffee grounds by means of a machine from the first category, the extract will typically contain 1.4 grams of coffee solids. If a coffee beverage is brewed from 7 grams of coffee grounds by means of a machine from the second category, the extract will typically contain 1.7 to 1.8 grams of coffee solids.

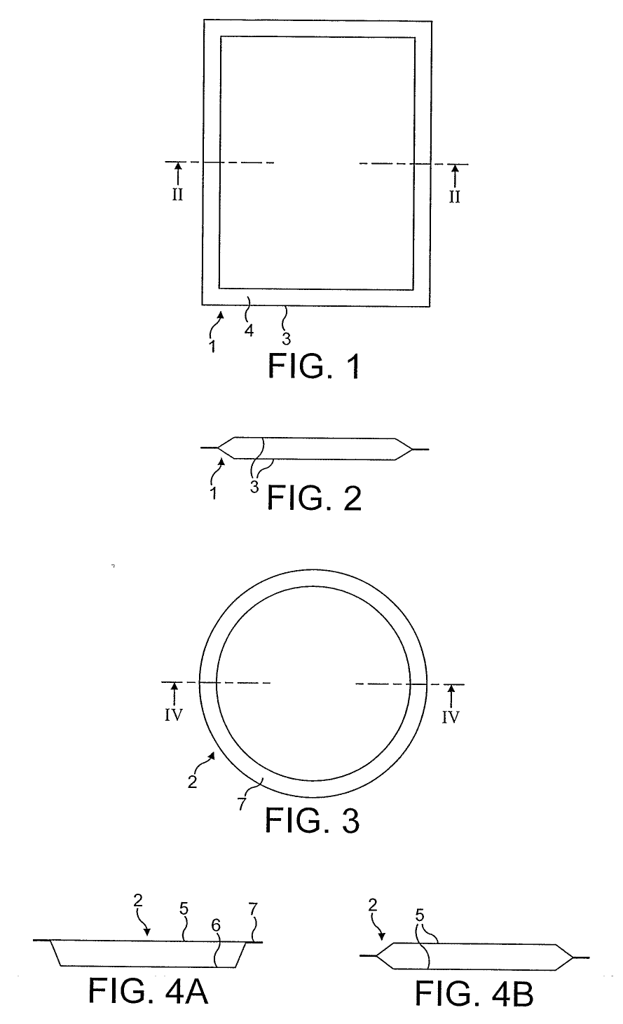

FIG. 1 a front view of a sachet for use in the kit according to the present invention.

FIG. 2 is a cross-section of the sachet shown in FIG. 1.

FIG. 3 is a bottom view of an extraction pad for use in the kit according to the present invention.

FIG. 4A is a cross-section of the extraction pad shown in FIG. 3.

FIG. 4B is a cross-section of a further extraction pad.

The Figures show the components of a kit for preparing a coffee beverage, in particular cappuccino, café latte, Wiener melange or varieties such as cappuccino vanille or cappuccino cinnamon, which kit comprises a first container, preferably a sachet 1, and a second container, preferably an extraction pad 2.

The sachet 1, shown in FIGS. 1 and 2, preferably comprises two rectangular or square sheets 3, e.g. 9×9 cm, of a laminate of polyester, aluminium and polyethylene, sealed along the edges 4.

The extraction pad 2, shown in FIGS. 3 to 4B, is pill-shaped and filled with coffee grounds. The pad 2 comprises a disk-shaped top sheet 5, having a diameter of 70 mm and manufactured from filtering paper, and a cup-shaped bottom sheet 6 also manufactured from filtering paper. The top and bottom sheets 5, 6 are sealed along the edges 7. FIG. 4B shows an alternative embodiment of the pad 2 comprising two disk-shaped sheets 5.

The sachet 1 contains a powdered creamer and/or a foamer ingredient which, upon addition of a liquid, induces the formation of or forms a foam, and, depending on the beverage for which the kit is intended, a coffee concentrate and/or sugar, cacao, vanille etc.

It is preferred that the total of coffee solids extractable from the coffee grounds in the second container and coffee concentrate in the first container corresponds to total coffee solids in a specific coffee beverage, i.e. typically 1.7 to 2.1 grams for cappuccino (135 ml water), 1.4 to 1.7 grams for café latte (150 ml water), and 1.6 to 1.9 grams for Wiener melange (150 ml water).

A preferred coffee concentrate is powdered instant coffee obtained by industrial extraction, typically at 15 bar and 180° C., and subsequent spray or freeze-drying.

Especially if the beverage is to contain no or only small amounts of creamer, it is preferred that a coffee concentrate comprises a soluble coffee beverage powder which, upon the addition of water, is capable of forming a coffee beverage having a foamed upper surface, the soluble coffee beverage powder comprising: a soluble gas containing matrix comprising soluble coffee solids and a soluble filler, the soluble filler constituting at least about 35% by weight of the dry matter of the matrix and is effective to increase the volume of the soluble coffee beverage powder incorporating gas. A preferred coffee concentrate is disclosed in EP 1 135 992, which is incorporated herein by reference.

A preferred foamer ingredient comprises a matrix containing carbohydrate and protein and entrapped gas, the gas being present in an amount to release upon addition of liquid at least about 1 ml of gas ambient conditions per gram of soluble foamer ingredient. An especially preferred foamer ingredient is disclosed in WO 01/08504, which is incorporated herein by reference.

Suitable compositions of the contents of the sachet are as follows:

| | TABLE |
|---|---|
| | Cappuccino |
| Coffee concentrate (g) | 0.4 |
| Creamer (g) | 7.1 |
| Foamer (g) | 3.0 |
| Sucre | — |
| Cacao | — |
| Vanille | — |
| Lactose (g) | 2.0 |
| | — |
| Total solids (g) | 12.5 |
| Water (ml) | 135 |

The amount of coffee grounds in the second container is in a range from 5 to 9 grams, preferably in a range from 6 to 8 grams, more specifically about 7 grams. Examples of suitable coffee beans for preparing the grounds include Columbia, Arabica, or Robusta.

A coffee beverage can be prepared by

dispensing a mixture of a coffee concentrate, a creamer and, optionally further ingredients, from a sachet into e.g. a beaker or glass,

placing, in a manner known in itself, a pad 2 in a low pressure espresso machine, such as the Bosch “Gustino”® TKP 3004 or the Philips Senseo® HD 7810, activating the espresso machine thus forcing hot water under pressure through the pad and extracting approximately 20% of coffee solids, i.e. approximately 1.4 grams, from the coffee grounds, and dispensing the coffee extract thus obtained into the receptacle.

The invention is not restricted to the above-described embodiments which can be varied in a number of ways within the scope of the claims. For instance, it is preferred that a plurality of sachets and a plurality of pads are contained in a common package. Optionally, the sachets hold different mixtures so as to enable the consumer to prepare different beverages with the contents of one package.

Further, it is preferred that the coffee beverage for which the kit is intended, in particular cappuccino, café latte, or Wiener melange, is indicated on the sachet respectively on the common package. Also, the coffee grounds and the coffee concentrate may be decaffeinated (‘decaf’).

1. Kit for preparing a coffee beverage, in particular cappuccino, café latte, Wiener melange or the like, comprising a first container holding at least a coffee beverage ingredient, preferably at least a coffee concentrate, a creamer and/or a foamer, to be dispensed into a receptacle and a second container holding ground coffee.

2. Kit according to claim 1, wherein the first container holds at least a coffee concentrate.

3. Kit according to claim 1 or 2, wherein the first container holds a creamer.

4. Kit according to any one of the preceding claims, wherein the first container holds a powdered soluble foamer ingredient which, upon addition of a liquid, induces the formation of or forms a foam.

5. Kit according to claim 4, wherein the foamer ingredient comprises a matrix containing carbohydrate and protein and entrapped gas, the gas being present in an amount to release upon addition of liquid at least about 1 ml of gas ambient conditions per gram of soluble foamer ingredient.

6. Kit according to claim to any one of the preceding claims, wherein the first container comprises a sachet.

7. Kit according to any one of the preceding claims, wherein the second container comprises an extraction pad, preferably made of filter paper.

8. Kit according to claim 7, wherein the pad is substantially flat and has a circular circumference and a diameter in a range from 6 to 8 cm.

9. Kit according to the preceding claims, wherein the total of coffee solids extractable from the coffee grounds in the second container and coffee concentrate in the first container corresponds to a specific coffee beverage.

10. Kit according to claim 9, wherein is the total of coffee solids extractable from the coffee grounds in the second container and coffee concentrate in the first container is in a range from 1.4 to 2.3 grams, preferably in a range from 1.5 to 2.0 grams.

11. Kit according to any one of the preceding claims, wherein the amount of coffee concentrate in the first container is in a range from 0.05 to 0.6 grams, preferably in a range from 0.1 to 0.5 grams.

12. Kit according to any one of the preceding claims, wherein the amount of coffee grounds in the second container is in a range from 5 to 9 grams, preferably in a range from 6 to 8 grams.

13. Kit according to any one of the preceding claims, wherein the coffee concentrate comprises a soluble coffee beverage powder which, upon the addition of water, is capable of forming a coffee beverage having a foamed upper surface, the soluble coffee beverage powder comprising: a soluble gas containing matrix comprising soluble coffee solids and a soluble filler, the soluble filler constituting at least about 35% by weight of the dry matter of the matrix and is effective to increase the volume of the soluble coffee beverage powder incorporating gas.

14. Kit according to any one of the preceding claims comprising a plurality of first containers and a plurality of second containers in a common package.

15. A container, preferably a first container as defined in any one of the preceding claims, holding at least a coffee beverage ingredient and provided with an indication that it can or should be used in combination with a second container holding ground coffee.

16. Method of preparing a coffee beverage comprising the steps of
dispensing at least a coffee concentrate and/or a foamer into a receptacle, and
dispensing a coffee extract from a coffee brewing machine, in particular a machine employing extraction pads, into the receptacle.

17. Method according to claim 16, comprising the step of dispensing a mixture of a coffee concentrate, a creamer and, optionally further ingredients, into the receptacle.

18. Method according to claim 16 or 17, wherein the total of the coffee solids in the extract and coffee concentrate dispensed into the receptacle corresponds to the recipe of a specific coffee beverage.

19. Method according to claim 18, wherein the total of coffee solids in the extract and coffee concentrate dispensed into the receptacle is in a range from 1.4 to 2.3 grams, preferably in a range from 1.5 to 2.0 grams.

20. Method according to any one of claim 16-19, wherein the amount of coffee concentrate dispensed into the receptacle is in a range from 0.05 to 0.6 grams, preferably in a range from 0.1 to 0.5 grams.
